(19) United States
(12) Patent Application Publication
(10) Pub. No.: US 2019/0137096 A1
(43) Pub. Date: May 9, 2019

(54) PERFORATED FLAME HOLDER SUPPORT STRUCTURE WITH HEATING ELEMENT

(71) Applicant: ClearSign Combustion Corporation, Seattle, WA (US)

(72) Inventors: DONALD KENDRICK, BELLEVUE, WA (US); DOUGLAS W. KARKOW, MANCHESTER, IA (US); JAMES DANSIE, RENTON, WA (US); MATT HOSIE, BROKEN ARROW, OK (US); CHRISTOPHER A. WIKLOF, EVERETT, WA (US)

(21) Appl. No.: 16/242,373

(22) Filed: Jan. 8, 2019

Related U.S. Application Data
(63) Continuation-in-part of application No. 15/702,614, filed on Sep. 12, 2017.
Application No. 15/702,614 is a continuation of application No. 14/762,155, filed on Jul. 20, 2015, now Pat. No. 9,797,595.
Application No. 14/762,155 is a continuation-in-part of application No. 14/763,738, filed on Jul. 27, 2015, now Pat. No. 10,077,899.
(60) Provisional application No. 61/765,022, filed on Feb. 14, 2013.
(60) Provisional application No. 61/931,407, filed on Jan. 24, 2014.
(60) Provisional application No. 61/765,022, filed on Feb. 14, 2013.
(60) Provisional application No. 61/931,407, filed on Jan. 24, 2014.
(60) Provisional application No. 62/614,643, filed on Jan. 8, 2018.

(51) Int. Cl. F23C 99/00; F23D 14/84; F23D 14/74; F27D 11/06; F23N 1/00; F23N 1/02; F23N 5/00; F23C 6/04; F23C 9/06; F23D 14/26; F23D 11/02; F23D 11/38; F23L 7/00; F23D 14/02; F23D 14/24; F23N 5/26; F23N 5/10; F23D 14/14; F23D 11/40; F23D 11/44; F23D 11/42

(52) U.S. Cl. CPC F23C 99/001; F23D 2203/1012; F23D 14/74; F27D 11/06; F23N 1/00; F23N 1/02; F23N 5/00; F23C 6/042; F23C 9/06; F23D 14/26; F23D 11/02; F23D 11/383; F23D 11/38; F23L 7/007; F23N 1/002; F23D 14/02; F23D 14/24; F23N 5/265; F23N 5/10; F23D 14/145; F23D 11/406; F23D 11/446; F23D 14/14; F23D 11/448; F23D 11/42; Y02T 50/677; F23D 2203/104; F23D 2207/00; F23D 2203/102; F23D 2203/1023; F23C 2201/00; F23N 2900/00; F23D 2208/10; F23C 2900/00; F23D 2203/105; F23N 2021/00; F23N 2027/22; F23D 14/84

(57) ABSTRACT

In a fuel and oxidant combustion system, a flame holder support structure includes a heating element that receives electrical energy from an electrical power source. The heating element is raised to an auto-ignition temperature of a fuel and oxidant mixture directed, along an axis proximate the flame holder support structure, to a flame holder for combustion thereof.

### CROSS REFERENCE TO RELATED APPLICATIONS

The present application is a Continuation-in-Part of co-pending U.S. patent application Ser. No. 15/702,614, entitled “FUEL COMBUSTION SYSTEM WITH A PERFORATED REACTION HOLDER,” filed Sep. 12, 2017 (docket number 2651-188-05). Co-pending U.S. patent application Ser. No. 15/702,614 is a Continuation of U.S. patent application Ser. No. 14/762,155, entitled “FUEL COMBUSTION SYSTEM WITH A PERFORATED REACTION HOLDER,” filed Jul. 20, 2015, now issued as U.S. Pat. No. 9,797,595, issued Oct. 24, 2017 (docket number 2651-188-03). U.S. patent application Ser. No. 14/762,155 is a U.S. National Phase application under 35 U.S.C. 371 of International Patent Application No. PCT/US2014/016632, entitled “FUEL COMBUSTION SYSTEM WITH A PERFORATED REACTION HOLDER,” filed Feb. 14, 2014, now expired (docket number 2651-188-04). International Patent Application No. PCT/US2014/016632 claims the benefit of U.S. Provisional Patent Application No. 61/765,022, entitled “PERFORATED FLAME HOLDER AND BURNER INCLUDING A PERFORATED FLAME HOLDER,” filed Feb. 14, 2013, now expired (docket number 2651-172-02), and U.S. Provisional Patent Application No. 61/931,407, entitled “LOW NOx FIRE TUBE BOILER,” filed Jan. 24, 2014, now expired (docket number 2651-205-02).

The present application is also a Continuation-in-Part of U.S. patent application Ser. No. 14/763,738, entitled “STARTUP METHOD AND MECHANISM FOR A BURNER HAVING A PERFORATED FLAME HOLDER,” filed Jul. 27, 2015, now issued as U.S. Pat. No. 10,077,899, issued Sep. 18, 2018 (docket number 2651-204-03). U.S. patent application Ser. No. 14/763,738 is a U.S. National Phase application under 35 U.S.C. 371 of International Patent Application No. PCT/US2014/016622, entitled “STARTUP METHOD AND MECHANISM FOR A BURNER HAVING A PERFORATED FLAME HOLDER,” filed Feb. 14, 2014, now expired (docket number 2651-204-04). International Patent Application No. PCT/US2014/016622 claims the benefit of U.S. Provisional Patent Application No. 61/765,022, entitled “PERFORATED FLAME HOLDER AND BURNER INCLUDING A PERFORATED FLAME HOLDER,” filed Feb. 14, 2013, now expired (docket number 2651-172-02), and U.S. Provisional Patent Application No. 61/931,407, entitled “LOW NOx FIRE TUBE BOILER,” filed Jan. 24, 2014, now expired (docket number 2651-205-02).

The present application also claims priority benefit from co-pending U.S. Provisional Patent Application No. 62/614,643, entitled “PERFORATED FLAME HOLDER SUPPORT STRUCTURE WITH HEATING ELEMENT,” filed Jan. 8, 2018 (docket number 2651-324-02).

Each of the foregoing applications, to the extent not inconsistent with the disclosure herein, is incorporated by reference.

### SUMMARY

According to an embodiment, a burner system includes a distal flame holder, a fuel and oxidant source configured to output a fuel and oxidant mixture along an axis, and a flame holder spaced away from the fuel and oxidant source, positioned on or near the axis to receive the fuel and oxidant mixture. A flame holder support structure is operatively coupled to the flame holder. An electrical power supply is operatively coupled to the flame holder or flame holder support structure and configured to provide electrical energy to the flame holder or flame holder support structure. The flame holder support structure may include a heater configured to employ the electrical energy to raise the temperature of the flame holder or the flame holder support structure at least to a temperature corresponding to an auto-ignition temperature of the fuel and oxidant mixture.

According to an embodiment, a method of stabilizing a flame in a burner system includes supplying electrical energy to a flame holder or flame holder support structure configured for physical support of a flame holder, where the flame holder support structure is disposed between the flame holder and a fuel and oxidant source. The method further includes raising the temperature of the flame holder or the flame holder support structure, using the electrical energy, at least to a temperature corresponding to an auto-ignition temperature of a fuel and oxidant mixture. The fuel and oxidant mixture is supplied along an axis, the fuel and oxidant mixture being supplied by the fuel and oxidant source. The fuel and oxidant mixture may be heated between the fuel and oxidant source and the flame holder. The method further includes receiving the (heated) fuel and oxidant mixture at the flame holder spaced a distance from the fuel and oxidant source. Additionally or alternatively, the fuel and oxidant mixture may be heated by exposure to entrained flue gas produced in the combustion reaction. In another embodiment, the perforated flame holder may receive a majority of the heating.

### BRIEF DESCRIPTION OF THE DRAWINGS

FIG. 1A is a block diagram of a burner system including a distal flame holder, according to an embodiment.

FIG. 1B is an alternative embodiment of a burner system including a distal flame holder, according to an embodiment.

FIG. 2 is a simplified diagram of a burner system including a perforated flame holder configured to hold a combustion reaction, according to an embodiment.

FIG. 3 is a side sectional diagram of a portion of the perforated flame holder of FIGS. 1A-B and 2, according to an embodiment.

FIG. 4 is a flow chart showing a method for operating a burner system including the perforated flame holder of FIGS. 1A-B, 2, and 3, according to an embodiment.

FIG. 5A is a simplified perspective view of a combustion system, including another alternative perforated flame holder, according to an embodiment.

FIG. 5B is a simplified side sectional diagram of a portion of the reticulated ceramic perforated flame holder of FIG. 5A, according to an embodiment.

FIG. 6 is a flow chart showing a method for stabilizing a flame in a burner system including the perforated flame holder and flame holder support structure of FIGS. 1A-B, 2, and 3, according to an embodiment.

FIGS. 7A-7D illustrate embodiments of a cross member of a flame holder support structure, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

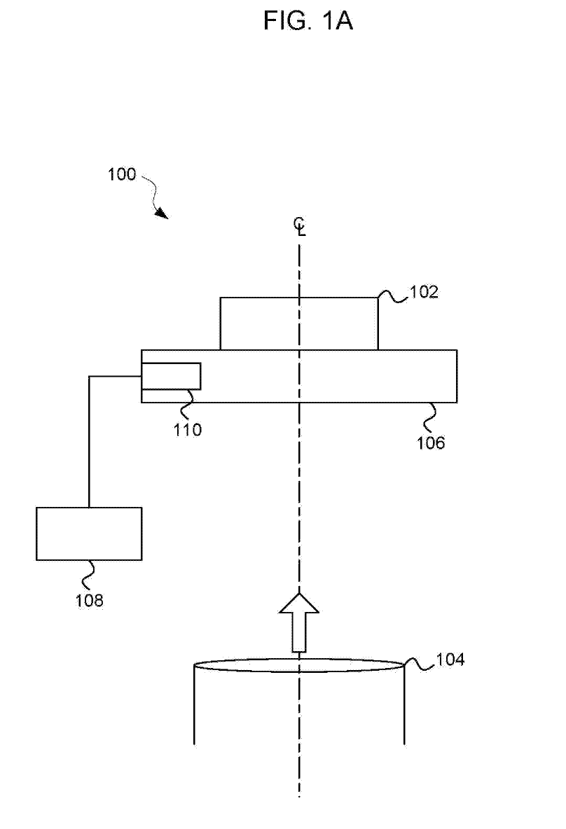

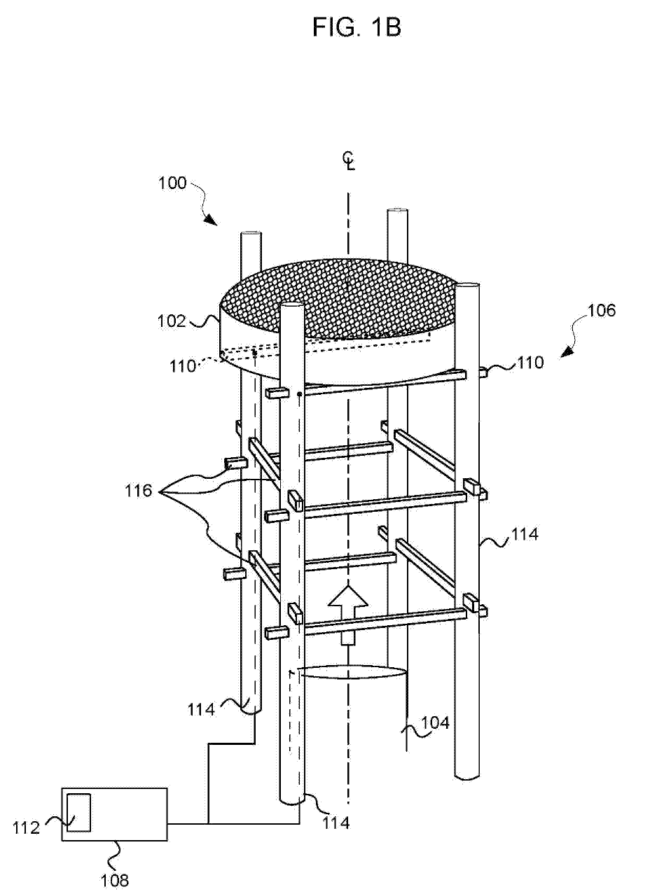

FIG. 1A is a block diagram of a burner system 100 including a distal flame holder 102, according to an embodiment. The burner system 100 may include a fuel and oxidant source 104 configured to output a fuel and oxidant mixture along an axis, and a flame holder 102 spaced away from the fuel and oxidant source 104, positioned on or near the axis to receive the fuel and oxidant mixture.

A flame holder support structure 106 may be operatively coupled to the flame holder 102. An electrical power supply 108 may be operatively coupled to the flame holder support structure 106 and configured to provide electrical energy to the flame holder support structure 106. The flame holder support structure 106 may include a heater or heater element 110 configured to employ a portion of the electrical energy to raise the temperature of the flame holder support structure 106 at least to a temperature corresponding to an auto-ignition temperature of the fuel and oxidant mixture.

In the burner system 100, the heater or heater element 110 and the flame holder 102 may cause a combustion reaction of the fuel and oxidant mixture to remain stably associated with the flame holder 102. The flame holder 102 may include a perforated flame holder.

In some embodiments, the heater or heater element 110 may be directly coupled to the flame holder support structure 106. Alternatively, the heater 110 may be formed integrally with at least a portion of the flame holder support structure 106. In some embodiments, at least one of the heater 110 and at least a portion of the flame holder support structure 106 may be formed of a semiconductor material selected to undergo resistive heating (also known as Joule heating and ohmic heating) upon application of the electrical energy from the electrical power supply 108. In some embodiments, the electrical energy (or electrical current) may be conducted through the flame holder support structure 106 via, e.g., one or more wires, or other electrically conductive structures to convey electrical current to the heater element(s) 110. The semiconductor material may include at least one of silicon carbide and zirconium dioxide. For example, the flame holder support structure 106 may be formed from a silicon carbide material labeled STARBARS® manufactured by I Squared R Company, Inc.

The heater or heater element(s) 110 may be disposed proximate the flame holder 102 in order to realize an auto-ignition temperature of a fuel and oxidant mixture as the mixture reaches the flame holder 102. In other embodiments, the heater or heater element 110 may additionally be disposed or distributed along the flame holder support structure 106 disposed about the axis along which the fuel and oxidant or a mixture thereof are supplied. The flame holder support structure 106 may span a distance between the fuel and oxidant source 104 and the flame holder 102. It will be understood, by those having skill in the art, that the flame holder 102 may take any of many shapes and configurations including, but not limited to, one or more perforated flame holders discussed herein and in other patents and patent applications associated with the applicant.

In some embodiments, the heater or heater element 110 of the flame holder support structure 106 may be disposed a distance from the flame holder 102 such that the temperature of a fuel and oxidant mixture directed toward the flame holder 102 and passing the heater or heater element 110 may be raised before reaching the flame holder 102 in order to preheat the flame holder 102 during a startup period.

In some embodiments, a plurality of flame holders 102 may be employed either in series or as elements of an aggregate flame holder. In the case where the flame holders 102 are implemented in series, one or more of the flame holders 102 in the arrangement may be heated by a heater 110 disposed in, or constituting, one or more proximate flame holder support structure 106 elements. In some disclosed configurations, portions of the heater or heater element 110 may be separately controlled to realize different temperatures at each consecutive flame holder 102. For example, in some applications it may be desirable at times to raise the temperature of a first flame holder 102 to an auto-ignition temperature of the fuel and oxidant mixture, while subsequent heater(s) 110 may raise the temperature of corresponding flame holder(s) 102 to a temperature selected for a particular treatment of combustion products resulting from combustion at the first flame holder 102.

In the case of an aggregate flame holder 102, two or more flame holders 102 may be arranged side-by-side, and a plurality of flame holder support structure 106 elements may be arranged so that every distinct flame holder 102 element is proximate to or in contact with one or more flame holder support structure 106 elements each including a heater element 110. The heater elements 110 may be selectively controlled across such aggregate flame holder 102 in order, e.g., to compensate for non-uniformity of heat resulting from combustion and the like.

In other embodiments, the heater 110 may be distributed along the distance between the fuel and oxidant source 104 and the flame holder 102, and may be configured to incrementally heat the fuel and oxidant mixture as it passes from the fuel and oxidant source 104 to the flame holder 102. In some disclosed configurations, portions of the heater or heater element 110 may be separately controlled to realize different temperatures at selectable distances between fuel and oxidant source 104 and the flame holder 102. For example, in some applications it may be desirable at times to raise the temperature of the fuel and oxidant mixture to an auto-ignition temperature well before it reaches the flame holder 102, while at other times it may be desirable for the mixture to reach auto-ignition just as it reaches the flame holder 102.

The burner system 100 may include a controller 112 configured for controlling the amount of electric energy provided to the heater or heater element 110 based on one or more of heater application, user preference, sensed temperature at one or more positions, or the like. The controller 112 may be configured to adjust the amount of electrical energy supplied to each heater or heater element 110 (or all elements together) automatically, manually, or in a combination or alternation of automatically and manually. The controller 112 may be configured to control the heat produced by each of a plurality of heater elements 110 discussed in the various embodiments presented above or below, or in combinations of such embodiments.

In one embodiment, the controller 112 is configured to maintain heating during steady state operation of the burner system 100. The controller 112 can include control logic that controls operation of the heating element 110 responsive to conditions of the burner system 100 or conditions in an environment of the burner system 100 in order to maintain an operating condition of the burner system 100. The controller can control the heating element 110 to augment heat output by the combustion reaction to maintain a selected temperature or temperature range of the flame holder 102.

In one embodiment, the controller 112 can control the heating element 110 to maintain a temperature of the flame holder 102 during steady state operation. For example, the controller 112 can control the heating element 110 to provide heat to the flame holder 102 when the burner system 100 is using fuels that do not produce heat sufficient, by themselves, to maintain the flame holder 102 at a selected operating temperature (such as fuels referred to as “low BTU” fuels). In these cases, the controller 112 can cause the heating element 110 to provide heat to the flame holder 102 at a sufficient level to ensure that the flame holder 102 remains at or above the selected operating level.

In one embodiment, the controller 112 can control the heating element 110 to provide heat to the flame holder 102 when high thermal (cooling) loads are encountered by the burner system 100. The heavy thermal loads can result in an undesirable drop in the temperature of the flame holder 102. In these cases, the controller 112 can cause the heating element 110 to provide heat to the flame holder 102 at a sufficient level to ensure that the flame holder 102 remains at or above the selected operating level. In one embodiment, the controller 112 can receive input data from an operator indicating a desired operating temperature of the flame holder 102, a type of the fuel that will be utilized with the burner system 100, an expected thermal load, or other parameters that can determine how much heat should be output by the heating element 110 during operation of the burner system 100. The controller 112 can then control the heating element 110 in accordance with the input data.

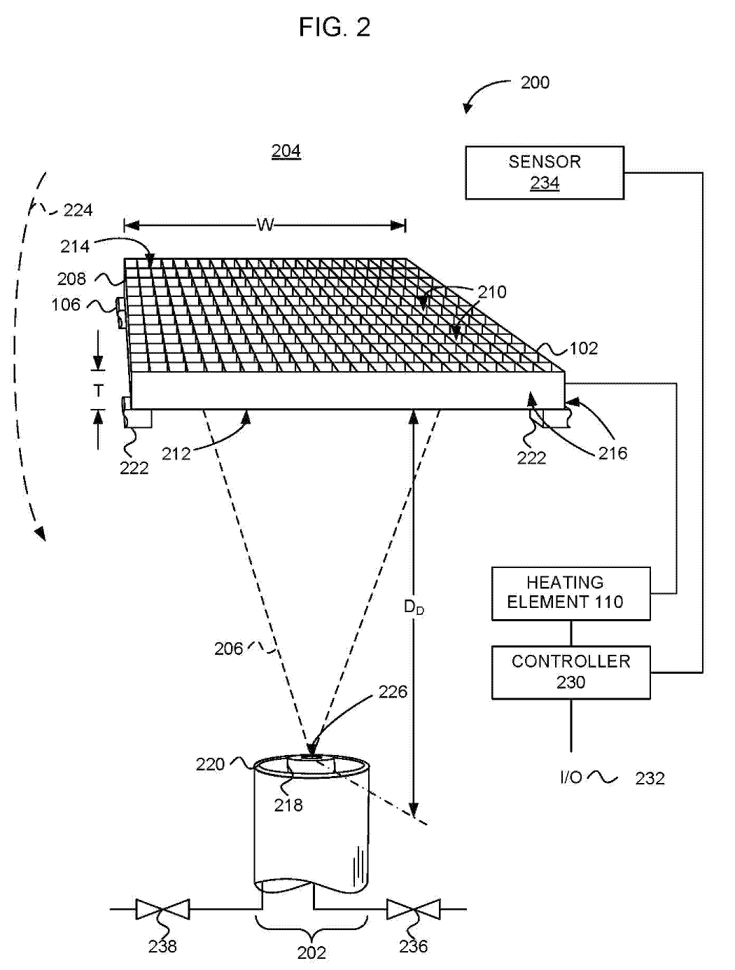

In one embodiment, the burner system 100 can include one or more sensors, for example sensor 234 of FIG. 2, that sense parameters of the burner system 100 or parameters in the environment of the burner system 100. The sensors can detect a temperature of the flame holder 102, a presence of a flame, heat output from the flame holder 102, a temperature of a thermal load, a flow rate of a thermal load, or other parameters of the burner system 100. The controller 112 can receive data or signals from the one or more sensors indicating conditions of the burner system 100. The controller 112 can then control the heating element 110 responsive to the data or signals received from the one or more sensors.

In some embodiments, the flame holder support structure 106 may include portions that span a distance between the fuel and oxidant source 104 and the flame holder 102. For example, in a non-limiting embodiment illustrated in FIG. 1B, the flame holder support structure 106 may include two or more longitudinal members 114 so disposed. One or more lateral or cross members 116 may span a distance between the longitudinal members 114, approximately parallel to the flame holder 102. For example, the flame holder support structure 106 may, in some embodiments, constitute a tower of sorts having four longitudinal members 114 disposed from a floor or wall of a furnace about the fuel and oxidant source 104 (e.g., one or more nozzles) and extending away from the floor or wall at least to a desired position of a flame holder 102. Crossmembers 116 disposed laterally between the longitudinal members 114 may be affixed to or integrally formed with the longitudinal members 114 to provide stability. The cross members 116 and the longitudinal members 114 may have complementary attachment structures for attachment to each other. In some instances, the cross members 116 and/or the longitudinal members 114 may support the flame holder 102 directly. Cross members 116 may be disposed at various distances along the longitudinal members 114 to permit different possible positions for placement of the flame holder 102, to permit placement of more than one flame holder 102, and/or for disposition of multiple heaters or heater elements 110 as described above. In some embodiments, the flame holder support structure 106 may include a plurality of possible positioning elements that cooperate to permit manual or automated changing of position of the flame holder 102.

In exemplary embodiments, as discussed further above, the flame holder support structure 106 may constitute a heater or heater element 110. For example, all, or portions, of one or more of the cross members 116 and/or the longitudinal members 114 may be formed of an electrically resistive material described herein, and may receive an amount of electrical energy to produce heat via resistive heating. In FIG. 1B, the heater 110 is indicated with a dashed bracket to indicate that some embodiments may utilize, as the heater 110, a portion of the flame holder support structure 106, while other embodiments may utilize all of the flame holder support structure 106 as the heater 110.

In some embodiments, the burner system 100 may additionally include a mechanism (not shown) for changing the length of the longitudinal members 114 extending from the floor or wall of the burner, e.g., for in-use control of the distance between the floor or wall of the furnace and the flame holder 102. Such mechanism may include, for example, a motor or crank disposed outside the furnace volume, the longitudinal members 114 penetrating the floor or wall and engaging the mechanism.

FIG. 2 is a simplified diagram of a burner system 200 including a perforated flame holder 102 configured to hold a combustion reaction, according to an embodiment. As used herein, the terms perforated flame holder, perforated reaction holder, porous flame holder, porous reaction holder, duplex, and duplex tile shall be considered synonymous unless further definition is provided.

Experiments performed by the inventors have shown that perforated flame holders 102 described herein can support very clean combustion. Specifically, in experimental use of burner systems 200 ranging from pilot scale to full scale, output of oxides of nitrogen (NOx) was measured to range from low single digit parts per million (ppm) down to undetectable (less than 1 ppm) concentration of NOx at the stack. These remarkable results were measured at 3% (dry) oxygen (O₂) concentration with undetectable carbon monoxide (CO) at stack temperatures typical of industrial furnace applications (1400—1600° F.). Moreover, these results did not require any extraordinary measures such as selective catalytic reduction (SCR), selective non-catalytic reduction (SNCR), water/steam injection, external flue gas recirculation (FGR), or other heroic extremes that may be required for conventional burners even to approach such clean combustion.

According to embodiments, the burner system 200 includes a fuel and oxidant source 202 (corresponding to the fuel and oxidant source 104 in FIGS. 1A-1B) disposed to output fuel and oxidant into a combustion volume 204 to form a fuel and oxidant mixture 206. As used herein, the terms fuel and oxidant mixture and fuel stream may be used interchangeably and considered synonymous depending on the context, unless further definition is provided. As used herein, the terms combustion volume, combustion chamber, furnace volume, and the like shall be considered synonymous unless further definition is provided. The perforated flame holder 102 is disposed in the combustion volume 204 and positioned to receive the fuel and oxidant mixture 206.

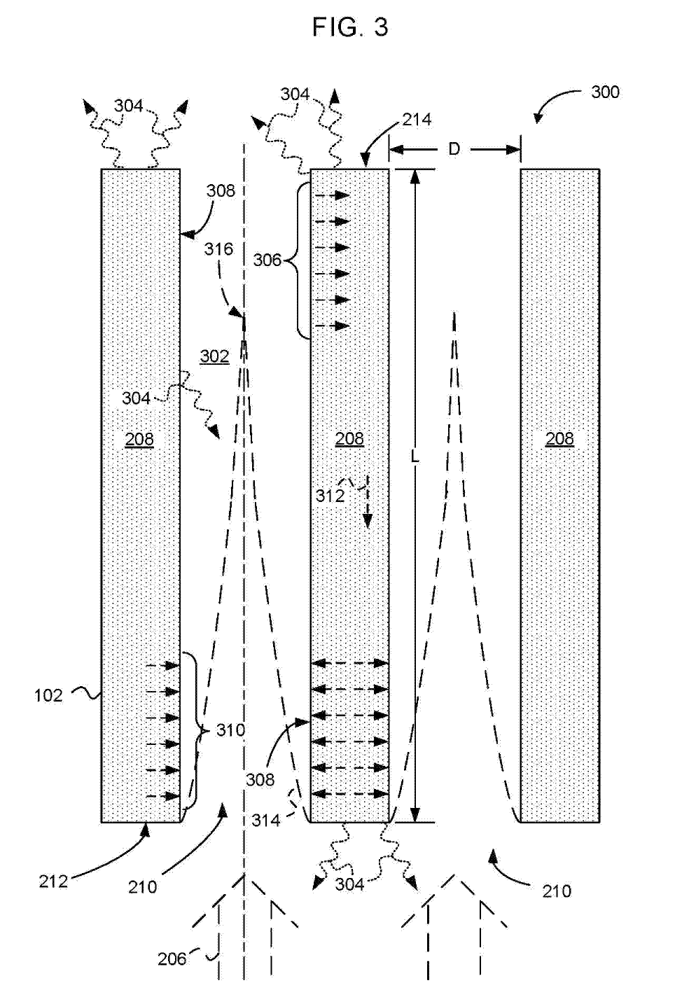

FIG. 3 is a side sectional diagram 300 of a portion of the perforated flame holder 102 of FIGS. 1A-B and 2, according to an embodiment. Referring to FIGS. 2 and 3, the perforated flame holder 102 includes a perforated flame holder body 208 defining a plurality of perforations 210 aligned to receive the fuel and oxidant mixture 206 from the fuel and oxidant source 202. As used herein, the terms perforation, pore, aperture, elongated aperture, and the like, in the context of the perforated flame holder 102, shall be considered synonymous unless further definition is provided. The perforations 210 are configured to collectively hold a combustion reaction 302 supported by the fuel and oxidant mixture 206.

The fuel can include hydrogen, a hydrocarbon gas, a vaporized hydrocarbon liquid, an atomized hydrocarbon liquid, or a powdered or pulverized solid. The fuel can be a single species or can include a mixture of gas(es), vapor(s), atomized liquid(s), and/or pulverized solid(s). For example, in a process heater application the fuel can include fuel gas or byproducts from the process that include carbon monoxide (CO), hydrogen (H₂), and methane (CH₄).

In another application the fuel can include natural gas (mostly CH₄) or propane (C₃H₈). In another application, the fuel can include #2 fuel oil or #6 fuel oil. Dual fuel applications and flexible fuel applications are similarly contemplated by the inventors. The oxidant can include oxygen carried by air, flue gas, and/or can include another oxidant, either pure or carried by a carrier gas. The terms oxidant and oxidizer shall be considered synonymous herein.

According to an embodiment, the perforated flame holder body 208 can be bounded by an input face 212 disposed to receive the fuel and oxidant mixture 206, an output face 214 facing away from the fuel and oxidant source 202, and a peripheral surface 216 defining a lateral extent of the perforated flame holder 102. The plurality of perforations 210, which are defined by the perforated flame holder body 208, extend from the input face 212 to the output face 214. The plurality of perforations 210 can receive the fuel and oxidant mixture 206 at the input face 212. The fuel and oxidant mixture 206 can then combust in or near the plurality of perforations 210 and combustion products can exit the plurality of perforations 210 at or near the output face 214.

According to an embodiment, the perforated flame holder 102 is configured to hold a majority of the combustion reaction 302 within the perforations 210. For example, on a steady-state basis, more than half the molecules of fuel output into the combustion volume 204 by the fuel and oxidant source 202 may be converted to combustion products between the input face 212 and the output face 214 of the perforated flame holder 102. According to an alternative interpretation, more than half of the heat or thermal energy output by the combustion reaction 302 may be output between the input face 212 and the output face 214 of the perforated flame holder 102. As used herein, the terms heat, heat energy, and thermal energy shall be considered synonymous unless further definition is provided. As used above, heat energy and thermal energy refer generally to the released chemical energy initially held by reactants during the combustion reaction 302. As used elsewhere herein, heat, heat energy and thermal energy correspond to a detectable temperature rise undergone by real bodies characterized by heat capacities. Under nominal operating conditions, the perforations 210 can be configured to collectively hold at least 80% of the combustion reaction 302 between the input face 212 and the output face 214 of the perforated flame holder 102. In some experiments, the inventors produced a combustion reaction 302 that was apparently wholly contained in the perforations 210 between the input face 212 and the output face 214 of the perforated flame holder 102. According to an alternative interpretation, the perforated flame holder 102 can support combustion between the input face 212 and output face 214 when combustion is “time-averaged.” For example, during transients such as before the perforated flame holder 102 is fully heated, or if too high a thermal (cooling) load is placed on the burner system, the combustion may travel somewhat downstream from the output face 214 of the perforated flame holder 102. Alternatively, if the thermal load is relatively low and/or the furnace temperature reaches a high level, the combustion may travel somewhat upstream of the input face 212 of the perforated flame holder 102.

While a “flame” is described in a manner intended for ease of description, it should be understood that in some instances, no visible flame is present. Combustion occurs primarily within the perforations 210, but the “glow” of combustion heat is dominated by a visible glow of the perforated flame holder 102 itself. In other instances, the inventors have noted transient “huffing” or “flashback” wherein a visible flame briefly ignites in a region lying between the input face 212 of the perforated flame holder 102 and a fuel nozzle 218, within the dilution region D_{D}. Such transient huffing or flashback is generally short in duration such that, on a time-averaged basis, a majority of combustion occurs within the perforations 210 of the perforated flame holder 102, between the input face 212 and the output face 214. In still other instances, the inventors have noted apparent combustion occurring downstream from the output face 214 of the perforated flame holder 102, but still a majority of combustion occurred within the perforated flame holder 102 as evidenced by continued visible glow from the perforated flame holder 102 that was observed.

The perforated flame holder 102 can be configured to receive heat from the combustion reaction 302 and output a portion of the received heat as thermal radiation 304 to heat-receiving structures (e.g., furnace walls and/or radiant section working fluid tubes) in or adjacent to the combustion volume 204. As used herein, terms such as radiation, thermal radiation, radiant heat, heat radiation, etc., are to be construed as being substantially synonymous, unless further definition is provided. Specifically, such terms refer to blackbody-type radiation of electromagnetic energy, primarily at infrared wavelengths, but also at visible wavelengths owing to elevated temperature of the perforated flame holder body 208.

Referring especially to FIG. 3, the perforated flame holder 102 outputs another portion of the received heat to the fuel and oxidant mixture 206 received at the input face 212 of the perforated flame holder 102. The perforated flame holder body 208 may receive heat from the combustion reaction 302 at least in heat receiving regions 306 of perforation walls 308. Experimental evidence has suggested to the inventors that the position of the heat receiving regions 306, or at least the position corresponding to a maximum rate of receipt of heat, can vary along the length of the perforation walls 308. In some experiments, the location of maximum receipt of heat was apparently between ⅓ and ½ of the distance from the input face 212 to the output face 214 (i.e., somewhat nearer to the input face 212 than to the output face 214). The inventors contemplate that the heat receiving regions 306 may lie nearer to the output face 214 of the perforated flame holder 102 under other conditions. Most probably, there is no clearly defined edge of the heat receiving regions 306 (or for that matter, heat output regions 310, described below). For ease of understanding, the heat receiving regions 306 and the heat output regions 310 will be described as particular regions 306, 310.

The perforated flame holder body 208 can be characterized by a heat capacity. The perforated flame holder body 208 may hold thermal energy from the combustion reaction 302 in an amount corresponding to the heat capacity multiplied by temperature rise, and transfer the thermal energy from the heat receiving regions 306 to the heat output regions 310 of the perforation walls 308. Generally, the heat output regions 310 are nearer to the input face 212 than are the heat receiving regions 306. According to one interpretation, the perforated flame holder body 208 can transfer heat from the heat receiving regions 306 to the heat output regions 310 via thermal radiation, depicted graphically as 304. According to another interpretation, the perforated flame holder body 208 can transfer heat from the heat receiving regions 306 to the heat output regions 310 via heat conduction along heat conduction paths 312. The inventors contemplate that multiple heat transfer mechanisms including conduction, radiation, and possibly convection may be operative in transferring heat from the heat receiving regions 306 to the heat output regions 310. In this way, the perforated flame holder 102 may act as a heat source to maintain the combustion reaction 302, even under conditions where a combustion reaction 302 would not be stable when supported from a conventional flame holder 102.

The inventors believe that the perforated flame holder 102 causes the combustion reaction 302 to begin within thermal boundary layers 314 formed adjacent to walls 308 of the perforations 210. Insofar as combustion is generally understood to include a large number of individual reactions, and since a large portion of combustion energy is released within the perforated flame holder 102, it is apparent that at least a majority of the individual reactions occur within the perforated flame holder 102. As the relatively cool fuel and oxidant mixture 206 approaches the input face 212, the flow is split into portions that respectively travel through individual perforations 210. The hot perforated flame holder body 208 transfers heat to the fluid, notably within thermal boundary layers 314 that progressively thicken as more and more heat is transferred to the incoming fuel and oxidant mixture 206. After reaching a combustion temperature (e.g., the auto-ignition temperature of the fuel), the reactants continue to flow while a chemical ignition delay time elapses, over which time the combustion reaction 302 occurs. Accordingly, the combustion reaction 302 is shown as occurring within the thermal boundary layers 314. As flow progresses, the thermal boundary layers 314 merge at a merger point 316. Ideally, the merger point 316 lies between the input face 212 and output face 214 that define the ends of the perforations 210. At some position along the length of a perforation 210, the combustion reaction 302 outputs more heat to the perforated flame holder body 208 than it receives from the perforated flame holder body 208. The heat is received at the heat receiving region 306, is held by the perforated flame holder body 208, and is transported to the heat output region 310 nearer to the input face 212, where the heat is transferred into the cool reactants (and any included diluent) to bring the reactants to the ignition temperature.

In an embodiment, each of the perforations 210 is characterized by a length L defined as a reaction fluid propagation path length between the input face 212 and the output face 214 of the perforated flame holder 102. As used herein, the term reaction fluid refers to matter that travels through a perforation 210. Near the input face 212, the reaction fluid includes the fuel and oxidant mixture 206 (optionally including nitrogen, flue gas, and/or other “non-reactive” species). Within the combustion reaction 302 region, the reaction fluid may include plasma associated with the combustion reaction 302, molecules of reactants and their constituent parts, any non-reactive species, reaction intermediates (including transition states), and reaction products. Near the output face 214, the reaction fluid may include reaction products and byproducts, non-reactive gas, and excess oxidant.

The plurality of perforations 210 can be each characterized by a transverse dimension D between opposing perforation walls 308. The inventors have found that stable combustion can be maintained in the perforated flame holder 102 if the length L of each perforation 210 is at least four times the transverse dimension D of the perforation 210. In other embodiments, the length L can be greater than six times the transverse dimension D. For example, experiments have been run where L is at least eight, at least twelve, at least sixteen, and at least twenty-four times the transverse dimension D. Preferably, the length L is sufficiently long for the thermal boundary layers 314 to form adjacent to the perforation walls 308 in a reaction fluid flowing through the perforations 210 to converge at the merger points 316 within the perforations 210 between the input face 212 and the output face 214 of the perforated flame holder 102. In experiments, the inventors have found L/D ratios between 12 and 48 to work well (i.e., produce low NOx, produce low CO, and maintain stable combustion).

The perforated flame holder body 208 can be configured to convey heat between adjacent perforations 210. The heat conveyed between adjacent perforations 210 can be selected to cause heat output from the combustion reaction portion 302 in a first perforation 210 to supply heat to stabilize a combustion reaction portion 302 in an adjacent perforation 210.

Referring especially to FIG. 2, the fuel and oxidant source 202 can further include the fuel nozzle 218, configured to output fuel, and an oxidant source 220 configured to output a fluid including the oxidant. For example, the fuel nozzle 218 can be configured to output pure fuel. The oxidant source 220 can be configured to output combustion air carrying oxygen, and optionally, flue gas.

The perforated flame holder 102 can be held by a perforated flame holder support structure 106, as an example of the flame holder support structure 106 in FIGS. 1A-B, configured to hold the perforated flame holder 102 at a dilution distance D_{D} away from the fuel nozzle 218. The fuel nozzle 218 can be configured to emit a fuel jet selected to entrain the oxidant to form the fuel and oxidant mixture 206 as the fuel jet and oxidant travel along a path to the perforated flame holder 102 through the dilution distance D_{D} between the fuel nozzle 218 and the perforated flame holder 102. Additionally or alternatively (particularly when a blower is used to deliver oxidant contained in combustion air), the oxidant or combustion air source 220 can be configured to entrain the fuel, and the fuel and oxidant mixture 206 travels through the dilution distance D_{D}. In some embodiments, a flue gas recirculation path 224 can be provided. Additionally or alternatively, the fuel nozzle 218 can be configured to emit a fuel jet selected to entrain the oxidant and to entrain flue gas as the fuel jet travels through the dilution distance D_{D} between the fuel nozzle 218 and the input face 212 of the perforated flame holder 102.

The fuel nozzle 218 can be configured to emit the fuel through one or more fuel orifices 226 having an inside diameter dimension that is referred to as “nozzle diameter.” The perforated flame holder support structure 106 can support the perforated flame holder 102 to receive the fuel and oxidant mixture 206 at the distance D_{D} away from the fuel nozzle 218 greater than 20 times the nozzle diameter. In another embodiment, the perforated flame holder 102 is disposed to receive the fuel and oxidant mixture 206 at the distance D_{D} away from the fuel nozzle 218 between 100 times and 1100 times the nozzle diameter. Preferably, the perforated flame holder support structure 106 is configured to hold the perforated flame holder 102 at a distance about 200 times or more of the nozzle diameter away from the fuel nozzle 218. When the fuel and oxidant mixture 206 travels about 200 times the nozzle diameter or more, the mixture is sufficiently homogenized to cause the combustion reaction 302 to produce minimal NOx.

The fuel and oxidant source 202 can alternatively include a premix fuel and oxidant source, according to an embodiment. A premix fuel and oxidant source 202 can include a premix chamber (not shown), a fuel nozzle 218 configured to output fuel into the premix chamber, and an oxidant (e.g., combustion air) channel configured to output the oxidant into the premix chamber. A flame arrestor can be disposed between the premix fuel and oxidant source 202 and the perforated flame holder 102 and be configured to prevent flame flashback into the premix fuel and oxidant source 202.

The oxidant source 220, whether configured for entrainment in the combustion volume 204 or for premixing, can include a blower configured to force the oxidant through the fuel and oxidant source 202.

The perforated flame holder support structure 106 can be configured to support the perforated flame holder 102 from a floor or wall (not shown) of the combustion volume 204, for example. In another embodiment, the perforated flame holder support structure 106 supports the perforated flame holder 102 from the fuel and oxidant source 202. Alternatively, the perforated flame holder support structure 106 can suspend the perforated flame holder 102 from an overhead structure (such as a flue, in the case of an up-fired system). The perforated flame holder support structure 106 can support the perforated flame holder 102 in various orientations and directions.

The perforated flame holder 102 can include a single perforated flame holder body 208. In another embodiment, the perforated flame holder 102 can include a plurality of adjacent perforated flame holder sections that collectively provide a tiled perforated flame holder 102.

The perforated flame holder support structure 106 can be configured to support the plurality of perforated flame holder sections. The perforated flame holder support structure 106 can include a metal superalloy, a cementatious, and/or ceramic refractory material. In an embodiment, the plurality of adjacent perforated flame holder sections can be joined with a fiber reinforced refractory cement.

The perforated flame holder 102 can have a width dimension W between opposite sides of the peripheral surface 216 at least twice a thickness dimension T between the input face 212 and the output face 214. In another embodiment, the perforated flame holder 102 can have a width dimension W between opposite sides of the peripheral surface 216 at least three times, at least six times, or at least nine times the thickness dimension T between the input face 212 and the output face 214 of the perforated flame holder 102.

In an embodiment, the perforated flame holder 102 can have a width dimension W less than a width of the combustion volume 204. This can allow the flue gas recirculation path 224 from above to below the perforated flame holder 102 to lie between the peripheral surface 216 of the perforated flame holder 102 and the combustion volume wall (not shown).

Referring again to both FIGS. 2 and 3, the perforations 210 can be of various shapes. In an embodiment, the perforations 210 can include elongated squares, each having a transverse dimension D between opposing sides of the squares. In another embodiment, the perforations 210 can include elongated hexagons, each having a transverse dimension D between opposing sides of the hexagons. In yet another embodiment, the perforations 210 can include hollow cylinders, each having a transverse dimension D corresponding to a diameter of the cylinder. In another embodiment, the perforations 210 can include truncated cones or truncated pyramids (e.g., frustums), each having a transverse dimension D radially symmetric relative to a length axis that extends from the input face 212 to the output face 214. In some embodiments, the perforations 210 can each have a lateral dimension D equal to or greater than a quenching distance of the flame based on standard reference conditions. Alternatively, the perforations 210 may have lateral dimension D less then than a standard reference quenching distance.

In one range of embodiments, each of the plurality of perforations 210 has a lateral dimension D between 0.05 inch and 1.0 inch. Preferably, each of the plurality of perforations 210 has a lateral dimension D between 0.1 inch and 0.5 inch. For example, the plurality of perforations 210 can each have a lateral dimension D of about 0.2 to 0.4 inch.

The void fraction of a perforated flame holder 102 is defined as the total volume of all perforations 210 in a section of the perforated flame holder 102 divided by a total volume of the perforated flame holder 102 including the perforated flame holder body 208 and all the perforations 210. The perforated flame holder 102 should have a void fraction between 0.10 and 0.90. In an embodiment, the perforated flame holder 102 can have a void fraction between 0.30 and 0.80. In another embodiment, the perforated flame holder 102 can have a void fraction of about 0.70. Using a void fraction of about 0.70 was found to be especially effective for producing very low NOx.

The perforated flame holder 102 can be formed from a fiber reinforced cast refractory material and/or a refractory material such as an aluminum silicate material. For example, the perforated flame holder 102 can be formed to include mullite or cordierite. Additionally or alternatively, the perforated flame holder body 208 can include a metal superalloy such as Inconel or Hastelloy. The perforated flame holder body 208 can define a honeycomb. Honeycomb is an industrial term of art that need not strictly refer to a hexagonal cross section and most usually includes cells of square cross section. Honeycombs of other cross sectional areas are also known.

The inventors have found that the perforated flame holder 102 can be formed from VERSAGRID® ceramic honeycomb, available from Applied Ceramics, Inc. of Doraville, S.C.

The perforations 210 can be parallel to one another and normal to the input and output faces 212, 214. In another embodiment, the perforations 210 can be parallel to one another, formed at an angle relative to the input and output faces 212, 214. In another embodiment, the perforations 210 can be non-parallel to one another. In another embodiment, the perforations 210 can be non-parallel to one another and non-intersecting. In another embodiment, the perforations 210 can be intersecting. The perforated flame holder body 208 can be one piece or can be formed from a plurality of sections.

In another embodiment, which is not necessarily preferred, the perforated flame holder 102 may be formed from reticulated ceramic material. The term “reticulated” refers to a netlike structure. Reticulated ceramic material is often made by dissolving a slurry into a sponge of specified porosity, allowing the slurry to harden, and burning away the sponge and curing the ceramic.

In another embodiment, which is not necessarily preferred, the perforated flame holder 102 may be formed from a ceramic material that has been punched, bored or cast to create channels.

In another embodiment, the perforated flame holder 102 can include a plurality of tubes or pipes bundled together. The plurality of perforations 210 can include hollow cylinders and can optionally also include interstitial spaces between the bundled tubes. In an embodiment, the plurality of tubes can include ceramic tubes. Refractory cement can be included between the tubes and configured to adhere the tubes together. In another embodiment, the plurality of tubes can include metal (e.g., superalloy) tubes. The plurality of tubes can be held together by a metal tension member circumferential to the plurality of tubes and arranged to hold the plurality of tubes together. The metal tension member can include stainless steel, a superalloy metal wire, and/or a superalloy metal band.

The perforated flame holder body 208 can alternatively include stacked perforated sheets of material, each sheet having openings that connect with openings of subjacent and superjacent sheets. The perforated sheets can include perforated metal sheets, ceramic sheets and/or expanded sheets. In another embodiment, the perforated flame holder body 208 can include discontinuous packing bodies such that the perforations 210 are formed in the interstitial spaces between the discontinuous packing bodies. In one example, the discontinuous packing bodies include structured packing shapes. In another example, the discontinuous packing bodies include random packing shapes. For example, the discontinuous packing bodies can include ceramic Raschig ring, ceramic Berl saddles, ceramic Intalox saddles, and/or metal rings or other shapes (e.g., Super Raschig Rings) that may be held together by a metal cage.

The inventors contemplate various explanations for why burner systems including the perforated flame holder 102 provide such clean combustion.

According to an embodiment, the perforated flame holder 102 may act as a heat source to maintain a combustion reaction 302 even under conditions where a combustion reaction 302 would not be stable when supported by a conventional flame holder. This capability can be leveraged to support combustion using a leaner fuel-to-oxidant mixture than is typically feasible. Thus, according to an embodiment, at the point where the fuel stream 206 contacts the input face 212 of the perforated flame holder 102, an average fuel-to-oxidant ratio of the fuel stream 206 is below a (conventional) lower combustion limit of the fuel component of the fuel stream 206—lower combustion limit defines the lowest concentration of fuel at which a fuel and oxidant mixture 206 will burn when exposed to a momentary ignition source under normal atmospheric pressure and an ambient temperature of 25° C. (77° F.).

The perforated flame holder 102 and systems including the perforated flame holder 102 described herein were found to provide substantially complete combustion of CO (single digit ppm down to undetectable, depending on experimental conditions), while supporting low NOx. According to one interpretation, such a performance can be achieved due to a sufficient mixing used to lower peak flame temperatures (among other strategies). Flame temperatures tend to peak under slightly rich conditions, which can be evident in any diffusion flame that is insufficiently mixed. By sufficiently mixing, a homogenous and slightly lean mixture can be achieved prior to combustion. This combination can result in reduced flame temperatures, and thus reduced NOx formation. In one embodiment, “slightly lean” may refer to 3% O₂, i.e., an equivalence ratio of ˜0.87. Use of even leaner mixtures is possible, but may result in elevated levels of O₂. Moreover, the inventors believe the perforation walls 308 may act as a heat sink for the combustion fluid. This effect may alternatively or additionally reduce combustion temperatures and lower NOx.

According to another interpretation, production of NOx can be reduced if the combustion reaction 302 occurs over a very short duration of time. Rapid combustion causes the reactants (including oxygen and entrained nitrogen) to be exposed to NOx-formation temperature for a time too short for NOx formation kinetics to cause significant production of NOx. The time required for the reactants to pass through the perforated flame holder 102 is very short compared to a conventional flame. The low NOx production associated with perforated flame holder combustion may thus be related to the short duration of time required for the reactants (and entrained nitrogen) to pass through the perforated flame holder 102.

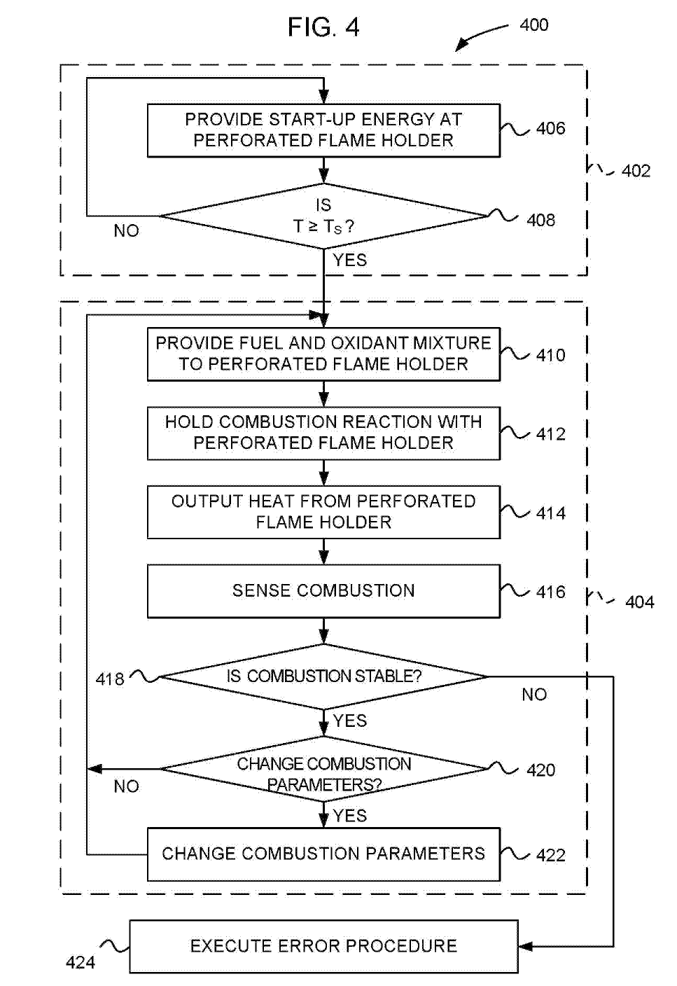

FIG. 4 is a flow chart showing a method 400 for operating a burner system including the perforated flame holder shown and described herein. To operate a burner system including a perforated flame holder, the perforated flame holder is first heated to a temperature sufficient to maintain combustion of the fuel and oxidant mixture.

According to a simplified description, the method 400 begins with step 402, wherein the perforated flame holder is preheated to a start-up temperature, T. After the perforated flame holder is raised to the start-up temperature, the method proceeds to step 404, wherein the fuel and oxidant are provided to the perforated flame holder and combustion is held by the perforated flame holder.

According to a more detailed description, step 402 begins with step 406, wherein start-up energy is provided at the perforated flame holder. Simultaneously or following providing start-up energy, a decision step 408 determines whether the temperature T of the perforated flame holder is at or above the start-up temperature, T. As long as the temperature of the perforated flame holder is below its start-up temperature, the method loops between steps 406 and 408 within the preheat step 402. In the decision step 408, if the temperature T of at least a predetermined portion of the perforated flame holder is greater than or equal to the start-up temperature, the method 400 proceeds to overall step 404, wherein fuel and oxidant is supplied to and combustion is held by the perforated flame holder.

Step 404 may be broken down into several discrete steps, at least some of which may occur simultaneously.

Proceeding from the decision step 408, a fuel and oxidant mixture is provided to the perforated flame holder, as shown in step 410. The fuel and oxidant may be provided by a fuel and oxidant source that includes a separate fuel nozzle and oxidant (e.g., combustion air) source, for example. In this approach, the fuel and oxidant are output in one or more directions selected to cause the fuel and oxidant mixture to be received by the input face of the perforated flame holder. The fuel may entrain the combustion air (or alternatively, the combustion air may dilute the fuel) to provide a fuel and oxidant mixture at the input face of the perforated flame holder at a fuel dilution selected for a stable combustion reaction that can be held within the perforations of the perforated flame holder.

Proceeding to step 412, the combustion reaction is held by the perforated flame holder.

In step 414, heat may be output from the perforated flame holder. The heat output from the perforated flame holder may be used to power an industrial process, heat a working fluid, generate electricity, or provide motive power, for example.

In an optional step 416, the presence of combustion may be sensed. Various sensing approaches have been used and are contemplated by the inventors. Generally, combustion held by the perforated flame holder is very stable and no unconventional sensing requirement is placed on the system. Combustion sensing may be performed using an infrared sensor, a video sensor, an ultraviolet sensor, a charged species sensor, thermocouple, thermopile, flame rod, and/or other combustion sensing apparatuses. In an additional or alternative variant of the optional step 416, a pilot flame or other ignition source may be provided to cause ignition of the fuel and oxidant mixture in the event combustion is lost at the perforated flame holder.

Proceeding to decision step 418, if combustion is sensed not to be stable, the method 400 may exit to step 424, wherein an error procedure is executed. For example, the error procedure may include turning off fuel flow, re-executing the preheating step 402, outputting an alarm signal, igniting a stand-by combustion system, or other steps. If, in the decision step 418, combustion in the perforated flame holder is determined to be stable, the method 400 proceeds to decision step 420, wherein it is determined if combustion parameters should be changed. If no combustion parameters are to be changed, the method loops (within step 404) back to step 410, and the combustion process continues. If a change in combustion parameters is indicated, the method 400 proceeds to step 422, wherein the combustion parameter change is executed. After changing the combustion parameter(s), the method loops (within step 404) back to step 410, and combustion continues.

Combustion parameters may be scheduled to be changed, for example, if a change in heat demand is encountered. For example, if less heat is required (e.g., due to decreased electricity demand, decreased motive power requirement, or lower industrial process throughput), the fuel and oxidant flow rate may be decreased in step 422. Conversely, if heat demand is increased, then fuel and oxidant flow may be increased. Additionally or alternatively, if the combustion system is in a start-up mode, then fuel and oxidant flow may be gradually increased to the perforated flame holder over one or more iterations of the loop within step 404.

Referring again to FIG. 2, the burner system 200 may include a heater 110 operatively coupled to the perforated flame holder 102. Such heater 110 may include the heater 110 of the flame holder support structure 106 discussed above with respect to FIGS. 1A-B, or may be additional to the heater 110. As described in conjunction with FIGS. 3 and 4, the perforated flame holder 102 operates by outputting heat to the incoming fuel and oxidant mixture 206. After combustion is established, this heat is provided by the combustion reaction 302; but before combustion is established, the heat may be provided by the heater 110.

Various heating apparatuses have been used and are contemplated by the inventors. In some embodiments, the heater 110 can include a flame holder 102 configured to support a flame disposed to heat the perforated flame holder 102, while other embodiments may utilize a resistive heater 110 affixed to or integrated with the flame holder support structure 106 as discussed above. The fuel and oxidant source 202 (such as fuel and oxidant source 104 of FIGS. 1A-B) can include a fuel nozzle 218 configured to emit a fuel stream 206 and an oxidant source 220 configured to output oxidant (e.g., combustion air) adjacent to the fuel stream 206. The fuel nozzle 218 and oxidant source 220 can be configured to output the fuel stream 206 to be progressively diluted by the oxidant (e.g., combustion air).

The perforated flame holder 102 can be disposed to receive a diluted fuel and oxidant mixture 206 that supports a combustion reaction 302 that is stabilized by the perforated flame holder 102 when the perforated flame holder 102 is at an operating temperature. A start-up flame holder, in contrast, can be configured to support a start-up flame at a location corresponding to a relatively unmixed fuel and oxidant mixture 206 that is stable without stabilization provided by the heated perforated flame holder 102. Alternatively, the heater or heating element 110 in FIGS. 1A-B may be operated to heat the fuel and oxidant mixture 206 as it travels toward the perforated flame holder 102 with or without a start-up flame holder.

The burner system 200 can further include a controller 230 operatively coupled to the heater 110 and to a data interface 232. For example, the controller 230 (also referenced herein as a control circuit 230) can be configured to control a start-up flame holder actuator configured to cause the start-up flame holder to hold the start-up flame when the perforated flame holder 102 needs to be pre-heated and to not hold the start-up flame when the perforated flame holder 102 is at an operating temperature (e.g., when T≥Tₛ). The controller 230 may include the controller 112 discussed with relation to FIG. 1B, or in some embodiments may be a separate controller.

Various approaches for actuating a start-up flame are contemplated. In one embodiment, the start-up flame holder includes a mechanically-actuated bluff body configured to be actuated to intercept the fuel and oxidant mixture 206 to cause heat-recycling and/or stabilizing vortices and thereby hold a start-up flame; or to be actuated to not intercept the fuel and oxidant mixture 206 to cause the fuel and oxidant mixture 206 to proceed to the perforated flame holder 102. In another embodiment, a fuel control valve, blower, and/or damper may be used to select a fuel and oxidant mixture 206 flow rate that is sufficiently low for a start-up flame to be jet-stabilized; and upon reaching a perforated flame holder 102 operating temperature, the flow rate may be increased to “blow out” the start-up flame. In another embodiment, the heater 110 may include an electrical power supply (such as the electrical power supply 108 in FIGS. 1A-B) operatively coupled to the controller 230 and configured to apply an electrical charge or voltage to the fuel and oxidant mixture 206. An electrically conductive start-up flame holder may be selectively coupled to a voltage ground or other voltage selected to attract the electrical charge in the fuel and oxidant mixture 206. The attraction of the electrical charge was found by the inventors to cause a start-up flame to be held by the electrically conductive start-up flame holder.

In another embodiment, the heater 110 may include an electrical resistance heater configured to output heat to the perforated flame holder 102 and/or (as discussed regarding the heater 110 in FIGS. 1A-B) to the fuel and oxidant mixture 206. The electrical resistance heater can be configured to heat up the perforated flame holder 102 and/or the flame holder support structure 106 to an operating temperature. The heater 110 can further include a power supply and a switch operable, under control of the controller 230, selectively to couple the electrical power supply 108 to the electrical resistance heater 110.

An electrical resistance heater 110 formed in the perforated flame holder 102 can be formed in various ways. For example, the electrical resistance heater 110 can be formed from KANTHAL® wire (available from Sandvik Materials Technology division of Sandvik AB of Hallstahammar, Sweden) threaded through at least a portion of the perforations 210 defined by the perforated flame holder body 208. Alternatively, the heater 110 can include an inductive heater, a high-energy beam heater (e.g., microwave or laser), a frictional heater, electro-resistive ceramic coatings, or other types of heating technologies.

Other forms of start-up apparatuses are contemplated. For example, the heater 110 can include an electrical discharge igniter or hot surface igniter configured to output a pulsed ignition to the oxidant and fuel. Additionally or alternatively, a start-up apparatus can include a pilot flame apparatus disposed to ignite the fuel and oxidant mixture 206 that would otherwise enter the perforated flame holder 102. The electrical discharge igniter, hot surface igniter, and/or pilot flame apparatus can be operatively coupled to the controller 230, which can cause the electrical discharge igniter or pilot flame apparatus to maintain combustion of the fuel and oxidant mixture 206 in or upstream from the perforated flame holder 102 before the perforated flame holder 102 is heated sufficiently to maintain combustion.

The burner system 200 can further include a sensor 234 operatively coupled to the control circuit 230. The sensor 234 can include a heat sensor configured to detect infrared radiation or a temperature of the perforated flame holder 102. The control circuit 230 can be configured to control the heating apparatus 110 responsive to input from the sensor 234. Optionally, a fuel control valve 236 can be operatively coupled to the controller 230 and configured to control a flow of fuel to the fuel and oxidant source 202. Additionally or alternatively, an oxidant blower or damper 238 can be operatively coupled to the controller 230 and configured to control flow of the oxidant (or combustion air).

The sensor 234 can further include a combustion sensor operatively coupled to the control circuit 230, the combustion sensor 234 being configured to detect a temperature, video image, and/or spectral characteristic of a combustion reaction 302 held by the perforated flame holder 102. The fuel control valve 236 can be configured to control a flow of fuel from a fuel source to the fuel and oxidant source 202. The controller 230 can be configured to control the fuel control valve 236 responsive to input from the combustion sensor 234. The controller 230 can be configured to control the fuel control valve 236 and/or oxidant blower or damper 238 to control a preheat flame type of heater 110 to heat the perforated flame holder 102 to an operating temperature. The controller 230 can similarly control the fuel control valve 236 and/or the oxidant blower or damper 238 to change the fuel and oxidant mixture 206 flow responsive to a heat demand change received as data via the data interface 232.

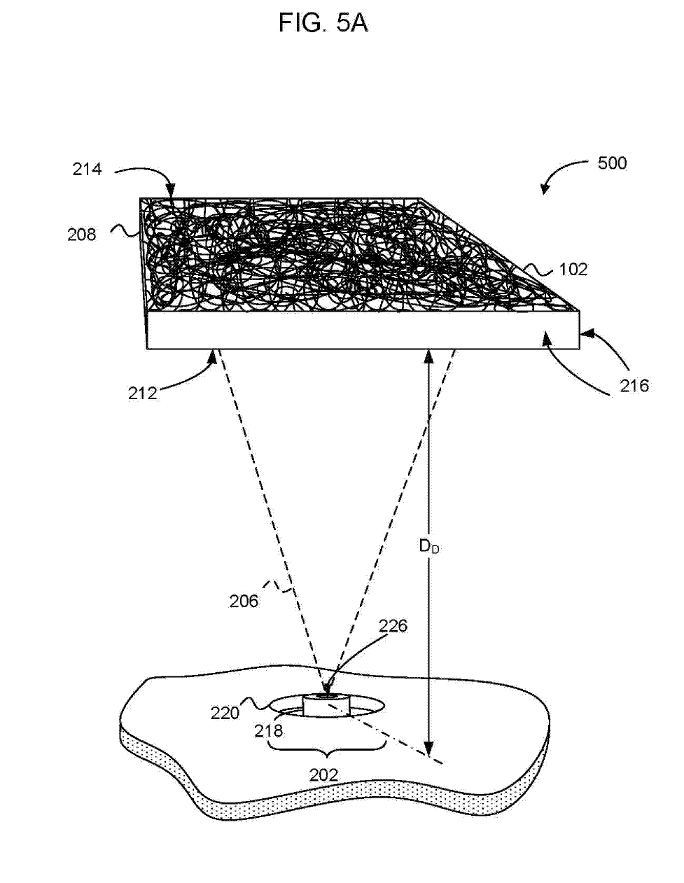

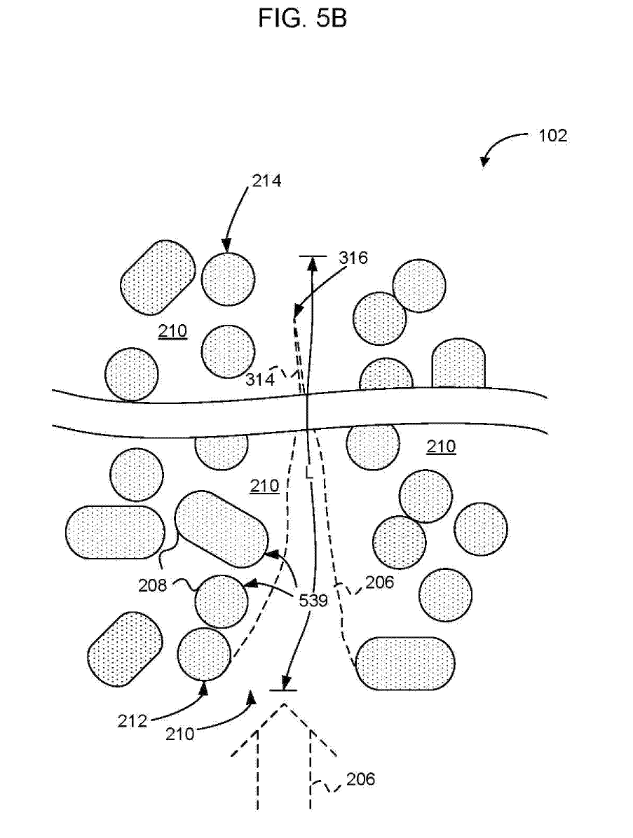

FIG. 5A is a simplified perspective view of a combustion system 500, including another alternative perforated flame holder 102, according to an embodiment. The perforated flame holder 102 is a reticulated ceramic perforated flame holder, according to an embodiment. FIG. 5B is a simplified side sectional diagram of a portion of the reticulated ceramic perforated flame holder 102 of FIG. 5A, according to an embodiment. The perforated flame holder 102 of FIGS. 5A, 5B can be implemented in the various combustion systems described herein, according to an embodiment. The perforated flame holder 102 is configured to support a combustion reaction (e.g., combustion reaction 302 of FIG. 3) of the fuel and oxidant mixture 206 received from the fuel and oxidant source 202 at least partially within the perforated flame holder 102. According to an embodiment, the perforated flame holder 102 can be configured to support a combustion reaction of the fuel and oxidant mixture 206 upstream, downstream, within, and adjacent to the reticulated ceramic perforated flame holder 102.

According to an embodiment, the perforated flame holder body 208 can include reticulated fibers 539. The reticulated fibers 539 can define branching perforations 210 that weave around and through the reticulated fibers 539. According to an embodiment, the perforations 210 are formed as passages between the reticulated fibers 539.

According to an embodiment, the reticulated fibers 539 are formed as a reticulated ceramic foam. According to an embodiment, the reticulated fibers 539 are formed using a reticulated polymer foam as a template. According to an embodiment, the reticulated fibers 539 can include alumina silicate. According to an embodiment, the reticulated fibers 539 can be formed from extruded mullite or cordierite. According to an embodiment, the reticulated fibers 539 can include Zirconia. According to an embodiment, the reticulated fibers 539 can include silicon carbide.

The term “reticulated fibers” refers to a netlike structure. According to an embodiment, the reticulated fibers 539 are formed from an extruded ceramic material. In reticulated fiber embodiments, the interaction between the fuel and oxidant mixture 206, the combustion reaction, and heat transfer to and from the perforated flame holder body 208 can function similarly to the embodiment shown and described above with respect to FIGS. 2-4. One difference in activity is a mixing between perforations 210, because the reticulated fibers 539 form a discontinuous perforated flame holder body 208 that allows flow back and forth between neighboring perforations 210.

According to an embodiment, the network of reticulated fibers 539 is sufficiently open for downstream reticulated fibers 539 to emit radiation for receipt by upstream reticulated fibers 539 for the purpose of heating the upstream reticulated fibers 539 sufficiently to maintain combustion of a fuel and oxidant mixture 206. Compared to a continuous perforated flame holder body 208, heat conduction paths (such as heat conduction paths 312 in FIG. 3) between reticulated fibers 539 are reduced due to separation of the reticulated fibers 539. This may cause relatively more heat to be transferred from a heat-receiving region or area (such as heat receiving region 306 in FIG. 3) to a heat-output region or area (such as heat-output region 310 of FIG. 3) of the reticulated fibers 539 via thermal radiation (shown as element 304 in FIG. 3).

According to an embodiment, individual perforations 210 may extend between an input face 212 to an output face 214 of the perforated flame holder 102. Perforations 210 may have varying lengths L. According to an embodiment, because the perforations 210 branch into and out of each other, individual perforations 210 are not clearly defined by a length L.

According to an embodiment, the perforated flame holder 102 is configured to support or hold a combustion reaction (see element 302 of FIG. 3) or a flame at least partially between the input face 212 and the output face 214. According to an embodiment, the input face 212 corresponds to a surface of the perforated flame holder 102 proximal to the fuel nozzle 218 or to a surface that first receives fuel. According to an embodiment, the input face 212 corresponds to an extent of the reticulated fibers 539 proximal to the fuel nozzle 218. According to an embodiment, the output face 214 corresponds to a surface distal to the fuel nozzle 218 or opposite the input face 212. According to an embodiment, the input face 212 corresponds to an extent of the reticulated fibers 539 distal to the fuel nozzle 218 or opposite to the input face 212.

According to an embodiment, the formation of thermal boundary layers 314, transfer of heat between the perforated flame holder body 208 and the gases flowing through the perforations 210, a characteristic perforation width dimension D, and the length L can each be regarded as related to an average or overall path through the perforated reaction holder 102. In other words, the dimension D can be determined as a root-mean-square of individual Dn values determined at each point along a flow path. Similarly, the length L can be a length that includes length contributed by tortuosity of the flow path, which may be somewhat longer than a straight line distance T_{RH} from the input face 212 to the output face 214 through the perforated reaction holder 102. According to an embodiment, the void fraction (expressed as (total perforated reaction holder 102 volume−reticulated fiber 539 volume)/total volume)) is about 70%.

According to an embodiment, the reticulated ceramic perforated flame holder 102 is a tile about 1″×4″×4″. According to an embodiment, the reticulated ceramic perforated flame holder 102 is characterized as 10 pores per inch. This means that a straight line measurement across a face of the perforated flame holder will, on average, cross 10 pores per inch. A 10 pore per inch perforated ceramic flame holder may actually be measured at 8 to 12 pores per inch, on average. Alternatively, a 10 pores per inch reticulated ceramic perforated flame holder may be characterized as 100 pores per square inch. Other materials and dimensions can also be used for a reticulated ceramic perforated flame holder 102 in accordance with principles of the present disclosure.

According to an embodiment, the reticulated ceramic perforated flame holder 102 can include shapes and dimensions other than those described herein. For example, the perforated flame holder 102 can include reticulated ceramic tiles that are larger or smaller than the dimensions set forth above. Additionally, the reticulated ceramic perforated flame holder 102 can include shapes other than generally cuboid shapes.

According to an embodiment, the reticulated ceramic perforated flame holder 102 can include multiple reticulated ceramic tiles. The multiple reticulated ceramic tiles can be joined together such that each ceramic tile is in direct contact with one or more adjacent reticulated ceramic tiles. The multiple reticulated ceramic tiles can collectively form a single perforated flame holder 102. Alternatively, each reticulated ceramic tile can be considered a distinct perforated flame holder 102.

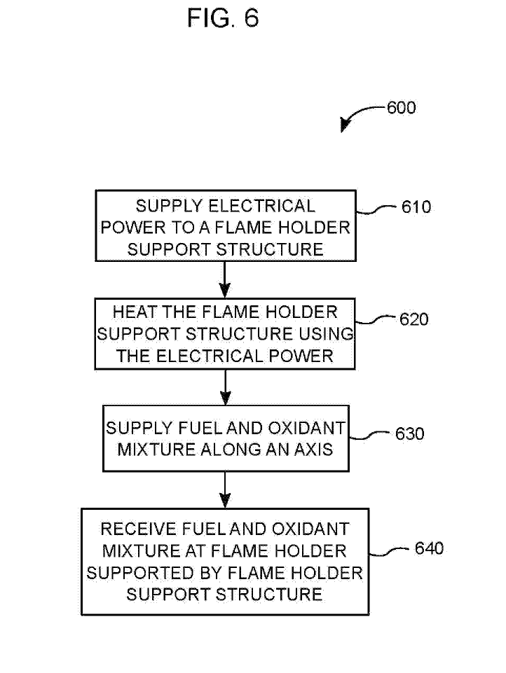

FIG. 6 is a flow chart 600 showing operations for stabilizing a flame in a burner system including the perforated flame holder 102 and flame holder support structure 106 of FIGS. 1A-1B, 2, and 3. In operation 610, electrical energy is supplied to a flame holder support structure, such as flame holder support structure 106. The electrical energy may be supplied from an electrical power source such as the electrical power supply 108 described above. In some embodiments the electrical energy may be conducted by the flame holder support structure 106 itself, whereas in other embodiments the electrical energy may be conducted by one or more conductive wires, strips, plasma, and/or other electrically conductive means. As discussed in greater detail above, the electrical energy may be conducted to an electrically powered heater, such as heater or heater element 110 in FIGS. 1A-1B, that can be affixed to or integrated with the flame holder support structure 106.

In operation 620, the temperature of the flame holder support structure 106 is raised by employing the electrical energy. As noted above, the electrical energy may be used to generate heat in a resistive heater or heater element 110 at least at a portion of the flame holder support structure 106. That is, in some embodiments at least a portion of the flame holder support structure 106 may constitute a resistive heater or heater element 110, while in other embodiments a separate resistive heater or heater element 110 may be affixed to the flame holder support structure 106 and receive electric current via the flame holder support structure 106. Those having ordinary skill in the art will acknowledge the utility of resistive heating in a resistive heater element (e.g., 110), also referred to as Joule heating or ohmic heating.

In operation 630, a fuel and oxidant mixture may be supplied or directed along and about an axis, such as the axis depicted with dashed lines in FIG. 1, between a fuel and oxidant source 104 and a perforated flame holder 102. When the fuel and oxidant mixture is so directed, its temperature is raised in passing by or through the flame holder support structure 106 that has been heated by the heater or heater element 110.

At operation 640, the fuel and oxidant mixture is received by the flame holder 102, the temperature of the fuel and oxidant mixture having been raised to an auto-ignition temperature of the fuel and oxidant mixture as (or before) it reaches the flame holder 102.

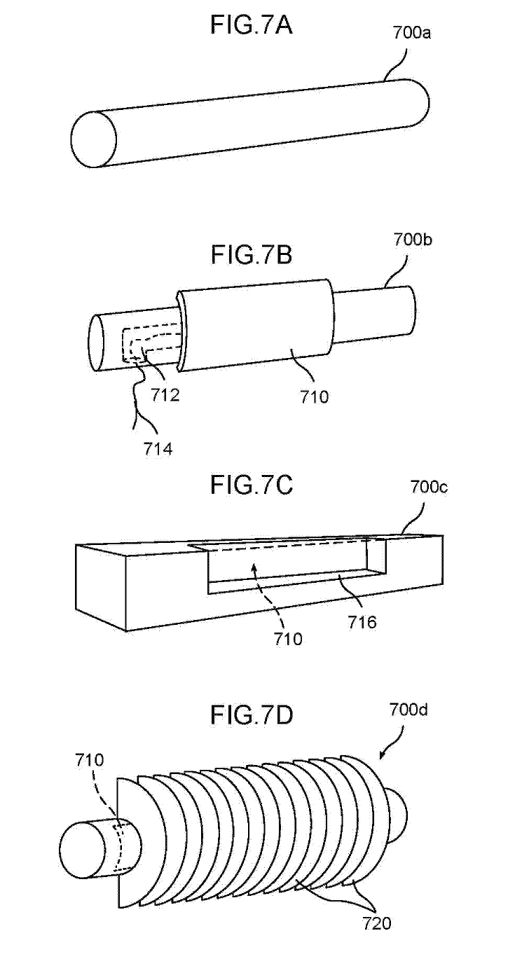

FIGS. 7A-7D illustrate embodiments of cross members 700a-700d (corresponding to cross member 116 in FIG. 1B) of a flame holder support structure such as the flame holder support structure 106. In some embodiments, the cross members 700a-700c may be smooth rods having a circular cross section (cross member 700a in FIG. 7A), an oval cross section (cross member 700b in FIG. 7B), or a rectangular cross section (cross member 700c in FIG. 7C) or the like. The cross member 700a of FIG. 7A may constitute in its entirely a heater or heater element (corresponding to heater or heater element 110 in FIGS. 1A-1B). For example, the cross member 700a may be entirely formed of an electrically resistive material configured to increase in temperature when receiving an electrical current. Alternatively, the cross member 700a may include a portion formed from a heater element 710 as discussed below with respect to FIGS. 7B-7C.

FIG. 7B illustrates a cross member 700b having an attached heater or heater element 710 (corresponding to heater or heater element 110 in FIGS. 1A-1B) may include a pathway 712 for an electrical wire 714. The pathway 712 may provide access to electrically power the electrical heater 710 through the cross member 700b. Although not necessarily illustrated in the figures, it will be acknowledged that all embodiments of cross members 700a-700d or other elements that include a heater or heater element 110 or 710 may incorporate such pathway 712. The attached heater or heater element 710 may be attached to the cross member 700b via mechanical or chemical means. For example, a heater or heater element 710 may be attached to a cross member 700b using any of hooks, screws, adhesives, or the like, or may depend on friction and gravity for positioning.

FIG. 7C illustrates a cross-member (e.g., 700c) having a void section 716 in which a heater 710 may be disposed or in which the heater or heater element 710 may be formed using an electrically resistive material at a heater position. The void section 716 may include a portion of one side of the cross member 700c as shown, or may include a larger portion of the cross member 700c.

FIG. 7D illustrates a cross member 700d in which a heater or heater element 710 may include one or more fins 720 formed from a material having high thermal conductivity. The fins 720 may be directed outward from the heater or heater element 710 and configured to increase heat transfer from a surface of the heater 710, and thereby raise the heating efficiency compared with a smooth rod alone. The fins 720 may be directed in at least the general direction of the fuel and oxidant output axis in order to transfer heat from each heater or heater element 710 to the fuel and oxidant mixture 206 as it travels toward the flame holder 102.

It will be acknowledged by those having skill in the art that the features defined above regarding cross members (700a-700d) may in some embodiments (not shown) be similarly applied to one or more longitudinal members (such as elements 114 in FIG. 1B) that support cross members 116. That is, a longitudinal member 114 may incorporate a heater or heater element, e.g., at a position proximate a flame holder 102.

In one embodiment, a method of operating a flame holder includes supporting, with a flame holder support structure, the flame holder in a position to receive fuel and oxidant from a fuel and oxidant source. The method can include raising a temperature of the flame holder to an auto-ignition temperature of the fuel and oxidant with an electrical heating element adjacent to the flame holder.

The method can include outputting the fuel and oxidant from the fuel and oxidant source after the flame holder has reached the auto-ignition temperature. The method can include supporting a combustion reaction of the fuel and oxidant with the flame holder.

In one embodiment, raising the temperature of the flame holder includes heating the flame holder support structure with the electrical heating element and transferring heat from the flame holder support structure to the flame holder.

In one embodiment, the method includes controlling operation of the electrical heating element with a controller operably coupled to the electrical heating element.

In one embodiment, the method includes maintaining a temperature of the flame holder during steady state operation of the flame holder by providing heat from the electrical heating element to the flame holder. In one embodiment, the method includes controlling, with the controller, a heat output of the electrical heating element responsive to a parameter in an environment of the flame holder during steady state operation of the flame holder. The parameter can include one or more of a temperature of the flame holder, a type of the fuel, and a presence of a thermal load.

In one embodiment, the method includes producing flue gas with the combustion reaction and heating the fuel and oxidant by entraining flue gas with the fuel and oxidant. In one embodiment, hot flue gas produced by the combustion reaction can be recirculated from the combustion reaction into a path of the fuel and oxidant as the fuel oxidant travels toward the flame holder.

In one embodiment, the heating element can heat the fuel and oxidant as the fuel and oxidant travel toward the perforated flame holder. The heated fuel and oxidant can raise the temperature of the flame holder or maintain the temperature of the flame holder at a selected level.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A burner system, comprising:
a fuel and oxidant source configured to output a fuel and oxidant mixture along an axis;
a flame holder spaced away from the fuel and oxidant source, and positioned to receive the fuel and oxidant mixture;
a flame holder support structure operatively coupled to the flame holder; and
an electrical power supply operatively coupled to the flame holder support structure and configured to provide electrical energy to at least a portion of the flame holder or the flame holder support structure;
wherein the flame holder support structure comprises a heater configured to employ the electrical energy to raise the temperature of the flame holder at least to a temperature corresponding to an auto-ignition temperature of the fuel and oxidant mixture.

2. The burner system of claim 1, wherein the flame holder support structure further comprises a tower structure having a plurality of longitudinal members, each spanning at least a distance between the flame holder and the fuel and oxidant source, and a plurality of cross members spanning at least a distance between the longitudinal members.

3. The burner system of claim 2, wherein the heater is integrally formed with at least one of the cross members of the flame holder support structure, the at least one cross member configured to receive the electrical energy from the electrical power supply.

4. The burner system of claim 3, further comprising a controller configured to control an amount of the electrical energy provided to the at least one cross member.

5. The burner system of claim 3, further comprising a controller configured to selectably control amounts of the electrical energy respectively supplied to each of at least two cross members each including a portion of the heater.

6. The burner system of claim 5, further comprising a temperature detection device, the controller configured to adjust the amounts of electrical energy supplied to the at least two cross members based on a temperature measured by the temperature detection device.

7. The burner system of claim 6, wherein the temperature detection device is disposed at an input face of the flame holder.

8. The burner system of claim 1, wherein arrangement and configuration of the heater and the flame holder cause a combustion reaction of the fuel and oxidant mixture to remain stably associated with the flame holder.

9. The burner system of claim 1, wherein the heater is directly coupled to the flame holder support structure.

10. The burner system of claim 1, wherein the heater is formed integrally with at least a portion of the flame holder support structure.

11. The burner system of claim 1, wherein the heater and at least a portion of the flame holder support structure comprise a semiconductor selected to undergo resistive heating upon application of the electrical energy from the electrical power supply.

12. The burner system of claim 11, wherein the semiconductor comprises silicon carbide.

13. The burner system of claim 11, wherein the semiconductor comprises zirconium dioxide.

14. The burner system of claim 1, wherein the flame holder comprises a perforated flame holder.

15. The burner system of claim 14, wherein the perforated flame holder is a reticulated ceramic perforated flame holder.

16. The burner system of claim 15, wherein the perforated flame holder includes a plurality of reticulated fibers.

17. The burner system of claim 16, wherein the perforated flame holder includes at least one of zirconia, alumina silicate, and silicon carbide.

18. The burner system of claim 16, wherein the reticulated fibers are formed from at least one of extruded mullite and cordierite.

19. The burner system of claim 16, wherein the perforated flame holder is configured to support a combustion reaction of the fuel and oxidant upstream, downstream, and within the perforated flame holder.

20. The burner system of claim 15, wherein the perforated flame holder has, on average, eight to twelve pores per inch.

21. The burner system of claim 15, wherein the perforated flame holder includes an input face, an output face, and a plurality of perforations extending between the input face and the output face.

22. The burner system of claim 16, wherein the perforations are formed as passages between the reticulated fibers.

23. The burner system of claim 22, wherein the perforations are branching perforations.

24. The burner system of claim 22, wherein the input face of the perforated flame holder corresponds to an extent of the reticulated fibers proximal to the fuel and oxidant source.

25. The burner system of claim 24, wherein the output face of the perforated flame holder corresponds to an extent of the reticulated fibers distal to the fuel and oxidant source.

26. The burner system of claim 25, wherein the perforated flame holder is configured to support at least a portion of the combustion reaction within the perforated flame holder between the input face and the output face.

27. A method of stabilizing a flame in a burner system, the method comprising:
supplying electrical energy to a flame holder support structure configured to physically support a flame holder spaced a distance from a fuel and oxidant source, the flame holder support structure disposed between the flame holder and the fuel and oxidant source;
raising the temperature of the flame holder support structure, using the electrical energy, at least to a temperature corresponding to an auto-ignition temperature of the fuel and oxidant mixture;
directing a fuel and oxidant mixture along an axis, the fuel and oxidant mixture being supplied by the fuel and oxidant source; and
receiving the fuel and oxidant mixture at the flame holder.

28. The method of claim 27, wherein said raising the temperature of the flame holder support structure causes a combustion reaction of the fuel and oxidant mixture to remain stably associated with the flame holder.

29. The method of claim 27, wherein said raising the temperature of the flame holder support structure includes supplying the electrical energy via the flame holder support structure to an electrically powered heater disposed at the flame holder support structure.

30. The method of claim 29, wherein the electrically powered heater is directly coupled to the flame holder support structure.

31. The method of claim 29, wherein the electrically powered heater is integrally formed as at least part of the flame holder support structure.

32. The method of claim 27, further comprising controlling, with a controller, supply of electrical energy to the flame holder support structure.

33. The method of claim 32, further comprising maintaining a temperature of the flame holder during steady state operation of the flame holder by supplying electrical energy to the flame holder support structure during steady state operation of the flame holder.

34. A method, comprising:
supporting, with a flame holder support structure, a flame holder in a position to receive fuel and oxidant from a fuel and oxidant source;
raising a temperature of the flame holder to an auto-ignition temperature of the fuel and oxidant with an electrical heating element adjacent to the flame holder;
outputting the fuel and oxidant from the fuel and oxidant source after the flame holder has reached the auto-ignition temperature; and
supporting a combustion reaction of the fuel and oxidant with the flame holder.

35. The method of claim 34, wherein raising the temperature of the flame holder includes heating the flame holder support structure with the electrical heating element and transferring heat from the flame holder support structure to the flame holder.

36. The method of claim 34, further comprising controlling operation of the electrical heating element with a controller operably coupled to the electrical heating element.

37. The method of claim 36, further comprising maintaining a temperature of the flame holder during steady state operation of the flame holder by providing heat from the electrical heating element to the flame holder.

38. The method of claim 37, controlling, with the controller, a heat output of the electrical heating element responsive to a parameter in an environment of the flame holder during steady state operation of the flame holder.

39. The method of claim 38, wherein the parameter is a temperature of the flame holder.

40. The method of claim 38, wherein the parameter is a type of the fuel.

41. The method of claim 38, wherein the parameter is a presence of a thermal load.

42. The method of claim 34, further comprising:
producing flue gas with the combustion reaction; and
heating the fuel and oxidant by entraining flue gas with the fuel and oxidant.

43. The method of claim 42, wherein the flame holder is a perforated flame holder.
